(19) United States
(12) Patent Application Publication
(10) Pub. No.: US 2005/0235133 A1
(43) Pub. Date: Oct. 20, 2005

(54) Slip multiple processing method, program and apparatus

(75) Inventors: Yoshiyuki Terai, Kawasaki (JP); Isamu Kawamura, Kawasaki (JP); Yoshihiro Hirano, Kawasaki (JP)

Correspondence Address: GREER, BURNS & CRAIN, 300 S WACKER DR, 25TH FLOOR, CHICAGO, IL, 60606, US

(73) Assignee: Fujitsu Limited

(21) Appl. No.: 10/931,303

(22) Filed: Aug. 31, 2004

(30) Foreign Application Priority Data
Apr. 12, 2004 (JP) 2004-116412

(51) Int. Cl. G06F 15/76

(52) U.S. Cl. 712/1

(57) ABSTRACT

Slips each having a unique number are inputted and retained in an input queue. Slips of the number corresponding to the multiplicity level of the business-related processing are taken out in the order of older input from the slips retained in the input queue to assign management numbers to the slips, after which a consolidated-format slip is produced by consolidating the slips taken out. During the multiple processing, the consolidated-format slip is divided into single slips, business-related processes of the number corresponding to the multiplicity level are executed in parallel and the slips processed are consolidated and delivered to the next multiple process. When all of the multiple processes have been completed, the consolidated-format slip obtained as the result of processing is divided into slips (single slips) and outputted in the order of their input.

### BACKGROUND OF THE INVENTION

1. Field of the Invention

The present invention relates generally to a program, method and apparatus for slip multiple processing, that multiple-process necessary business-related processes based on the contents of a large number of slips inputted and, more particularly to a program, method and apparatus for slip multiple processing, that improve the processing performance while guaranteeing the processing order for slips.

2. Description of the Related Arts

Conventionally, in a business-related processing system such as the one in a bank or a company, various processes such as modification of slips, summation, storage of results, and communication are executed, and there often is a case where improvement of the performance of processing slips is required while assurance of the order of processing is demanded. Furthermore, there also often is a case where assurance of data taking into account the usage of the data is required, such as prevention of redundancy and lack of slips, and execution of the same processing as the previous one in re-execution. In these business-related processing, the performance improvement and assurance of the order of slips are tasks inconsistent with each other. The conventional business-related processing employs a method in which the order is controlled by storing the state of a plurality of slips being processed in a management list and determining whether or not each of those slips can be processed, or a method in which the order is assured in the first-in-first-out (FIFO) manner by providing a queue to all of the plurality of processes (see, e.g., Japanese Patent Application Laid-Open Publication No. 1992-021134).

However, in the conventional business-related processing using a management list, it is difficult to arrange the processing for general-purpose use because it is necessary to define each relation between a slip and a process, and this leads to dependency on a specific operation. Furthermore, to manage each of a large number of slips respectively increases redundant processes and, therefore, it is difficult to improve the processing performance. On the other hand, in the conventional method in which the order is assured by providing a queue to all the processes, it is impossible to multiple-process the same one (1) process and, therefore, it is difficult to improve the processing performance any more.

### SUMMARY OF THE INVENTION

According to the present invention there are provided, for a business-related processing that handles slips, a program, method and apparatus for multiple processing, that can cope with both improvement of the processing performance and assurance of the slip order and that is arranged to be used for general purpose not dependent on any specific operation.

The present invention provides a program for slip multiple processing. The program of the present invention is operable to cause a computer to execute:
an input retaining step of inputting a slip with a unique number and retaining the slip in an input queue;
an input processing step of taking out slips of the number corresponding to multiplicity level of business-related processes, in the order of their age, from the slips retained in the input queue, assigning a management number to each of the corresponding number of slips, and thereafter, consolidating the corresponding number of slips to produce a consolidated-format slip;
a multiple processing step with one (1) or more stages, of dividing the consolidated-format slip into single slips and executing business-related processes of the number corresponding to the multiplicity level in parallel as well as outputting the processed single slips after consolidation into the consolidated-format slip; and
an output processing step of dividing the consolidated-format slip obtained from the multiple processing step into single slips and outputting the divided single slips in the order of their input. The term, “slips” used herein includes telegrams for controlling devices and systems and contained in signals, in addition to accounting books and vouchers used in business-related processes.

The business-related processes in the multiple processing step includes executing a slip modification, summation, result storage or communication.

The program of the present invention is further operable to cause the computer to execute a multiplicity level adjusting step of adjusting the value of the multiplicity level based on a processing sufficiency rate in the multiple processing step. The multiplicity level adjusting step includes:
a step of obtaining the rate of the number of times of multiple processing of slips of the number satisfying the current multiplicity level, against the number of times of multiple processing per unit time, as the processing sufficiency rate;
a multiplicity level increasing step of increasing the multiplicity level as a result of determining that the current multiplicity level is not sufficient when the processing sufficiency rate is larger than a predetermined increase threshold value; and
a multiplicity level decreasing step of decreasing the multiplicity level as a result of determining that the current multiplicity level is excessive when the processing sufficiency rate is smaller than a predetermined decrease threshold value.

The multiplicity level increasing step includes multiplying the current multiplicity level by a coefficient obtained by adding a predetermined increment to 1 (one) to find an increased multiplicity level and, when the increased multiplicity level reaches a predetermined maximal value, fixing the multiplicity level at the maximal value, and the multiplicity level decreasing step includes multiplying the current multiplicity level by a coefficient obtained by subtracting a predetermined decrement from 1 (one) to find a decreased multiplicity level and, when the decreased multiplicity level reaches a predetermined minimal value, fixing the multiplicity level at the minimal value. The input retaining step includes retaining in the input queue a slip having a unique number and a group number that designates consolidated processing, and the input processing step includes retrieving, in the order of input, slips of the number corresponding to the multiplicity level of the business-related processes including the oldest input slip having the same group number, and consolidating the retrieved slips to produce a consolidated format slip. The program of the present invention is further operable to cause the computer to execute:
a history storage step of storing history information including a unique number, a management number, and information specific to business-related processes during a first slip process in the multiple processing step; and
a re-processing step of, when the slip is returned to the input retaining step and is re-processed being included in the consolidated-format slip in the input processing step, succeeding the information specific to the last business-related process by referring to the history information and causing the multiple processing step to execute the same process based on the information specific to the business-related process. The re-processing step includes, if a plurality of slips have the same management number, taking out slips for a first process and taking out slips except those for the first process in the next process when the history information is referred to in the slip retrieval for producing the consolidated-format slip in the input processing step. The program of the present invention is further operable to cause the computer to execute a re-processing step of storing a consolidated-format slip in an internal queue at an intermediate stage of the multiple processing step including from the input processing step to the output processing step, and resuming the process from a consolidated-format slip stored in the internal queue used in the multiple processing step already executed when processing has failed during a specific step in the multiple processing step. The re-processing step includes deleting a consolidated-format slip stored in the internal queue in a preceding multiple processing step when a consolidated-format slip is stored in the internal queue in a following multiple processing step.

The present invention provides a slip multiple processing method. The slip multiple processing method of the present invention comprises:
an input retaining step of inputting a slip with a unique number and retaining the slip in an input queue;
an input processing step of taking out slips of the number corresponding to the multiplicity level of business-related processes, in the order of their age, from the slips retained in the input queue, assigning a management number to each of the corresponding number of slips, and thereafter, consolidating the corresponding number of slips to produce a consolidated-format slip;
a multiple processing step with one (1) or more stages, of dividing the consolidated-format slip into single slips and executing business-related processes of the number corresponding to the multiplicity level in parallel as well as outputting the processed single slips after consolidation into the consolidated-format slip; and
an output processing step of dividing the consolidated-format slip obtained from the multiple processing step into single slips and outputting the divided single slips in the order of their input.

The present invention provides a slip multiple processing apparatus. The slip multiple processing apparatus of the present invention comprises an input retaining unit for inputting a slip with a unique number and retaining the slip in an input queue; an input processing unit for taking out slips of the number corresponding to the multiplicity level of business-related processes, in the order of their age, from the slips retained in the input queue, the input processing unit assigning a management number to each of the corresponding number of slips, and thereafter consolidating the corresponding number of slips to produce a consolidated-format slip; a multiple processing unit with one (1) or more stages, for dividing the consolidated-format slip into single slips and executing business-related processes of the number corresponding to the multiplicity level in parallel, the multiple processing unit outputting the processed single slips after consolidation into the consolidated-format slip; and an output processing unit for dividing the consolidated-format slip obtained from the multiple processing unit into single slips and outputting the divided single slips in the order of their input. The details of the program and the slip multiple processing apparatus of the invention are basically same as those of the slip multiple processing method.

According to the invention, it is possible to cope with both improvement of the processing performance and assurance of the order for arbitrary business-related processing that handles slips and, furthermore, the apparatus of the invention is not dependent on any specific operation, is for general-purpose use, is easy to implement and may be applied as a basic function or a part as, for example, middle-ware used when business-related processing is automated and, simultaneously, business-use processing systems are made cooperate with each other. As a business-use processing system to which the invention may be applied, for example, there is a gateway system handling cooperation between banks based on a communication protocol arranged in the financial industry. In this communication processing, a specific protocol is employed and, for the operation types handling a large amount of data, virtual communication paths are provided at the application level and are controlled for upward and downward respectively for each operation type in order to enable multiple communications. In addition to communications executed based on a defined protocol, in order to execute cooperation at the operation level, arbitrary processes according to the operation types such as conversion of formats and conversion of character codes for slips, storage of processing history, checking are necessary. In communication processing, multiple processing is executed to cope with the increase of data amount. However, execution of multiple processing for general-purpose use is desired in a series of arbitrary processes at the application level in order to improve the processing performance for all the systems cooperating with each other as a whole. Furthermore, during the communication processing and the application processing, it is necessary to assure the order of processes of slips. In this manner, conventionally, a complicated mechanism such as creation of management lists is necessary in the processes for which improvement of the processing performance slips and assurance of the order are necessary. However, according to the invention, the assurance of the order of the slips can be achieved by executing business-related processing of one (1) or more stages to the slips as consolidated-format slips consolidated to the number based on the multiplicity level by assigning management numbers to each of the slips and, in each business-related processes, the processing performance can be improved by multiple-processing for one (1) same process by dividing each of the consolidated-format slips. Furthermore, the invention realizes its advantage with a simple approach in which, by assigning management numbers to each of a plurality of slips, the slips are consolidated into consolidated-format slips and are multiple-processed by dividing them into single slips when the are business-related processed. Therefore, complicated processes and large-scale computer apparatuses are not necessary. Furthermore, by arranging the apparatus to be general-purpose use, not dependent on a specific operation, application to various operations and implementation to products are possible. Furthermore, according to the invention, data assurance taking into account the usage of the data can be realized, such as prevention of redundancy and lack of slips, and assurance of the same processing in re-execution. The invention enhances the capability of the basic functions such as those required in the business-related processing and assurance of the order. Furthermore, optimization of the performance and the resources according to the contents of the processing, and easiness of usage can be realized by including an automatic adjusting mechanism for multiplicity level, by which the processing performance is secured by increasing the multiplicity level as the process sufficiency rate increases and the resources are saved by decreasing the multiplicity level as the process sufficiency rate decreases, based on the process sufficiency rate in multiple processing executed as a business-related processing.

The above and other objects, aspects, features and advantages of the present invention will become more apparent from the following detailed description when taken in conjunction with the accompanying drawings.

### BRIEF DESCRIPTION OF THE DRAWINGS

FIG. 1 shows a block diagram of a business-use system equipped with a slip multiple processing function of the invention;

FIG. 2 illustrates a program execution environment equipped with a slip multiple processing unit of the invention as middle-ware;

FIG. 3 illustrates a hardware environment of a computer executing a program for the slip multiple processing of the invention;

FIG. 4 illustrates a format of a slip assigned with a multiple processing management number, processed according to the invention;

FIG. 5 illustrates a specific example of a plurality of slips retrieved for consolidating them into a consolidated-format slip according to the invention;

FIG. 6 illustrates a consolidated-format slip produced by consolidating the slips in FIG. 5;

FIG. 7 illustrates schematically the slip multiple processing according to the invention;

FIG. 8 is a flowchart showing the slip multiple processing according to the invention;

FIG. 9 is a flowchart of a multiplicity level adjustment process according to the invention;

FIG. 10 illustrates schematically the slip multiple processing of the invention targeting slips assigned with group numbers;

FIGS. 11A and 11B together show a flowchart of the slip multiple processing of the invention including a process targeting slips assigned with group numbers in FIG. 10;

FIG. 12 illustrates an input process when executing re-processing utilizing history information stored in the first multiple processing;

FIGS. 13A and 13B together show a flowchart of slip multiple processing of the invention including re-processing by reference of the history information in FIG. 12;

FIGS. 14A and 14B are block diagrams of the slip multiple processing of the invention that improves the efficiency of re-processing by storing consolidated-format slips in an internal queue;

FIG. 15 illustrates transfer of slips to the internal queue in FIGS. 14A and 14B and re-execution when the process has failed; and

FIGS. 16A and 16B show block diagrams of functional composition when the slip multiple processing of the invention is applied to a financial gateway system between banking systems.

### DESCRIPTION OF THE PREFERRED EMBODIMENTS

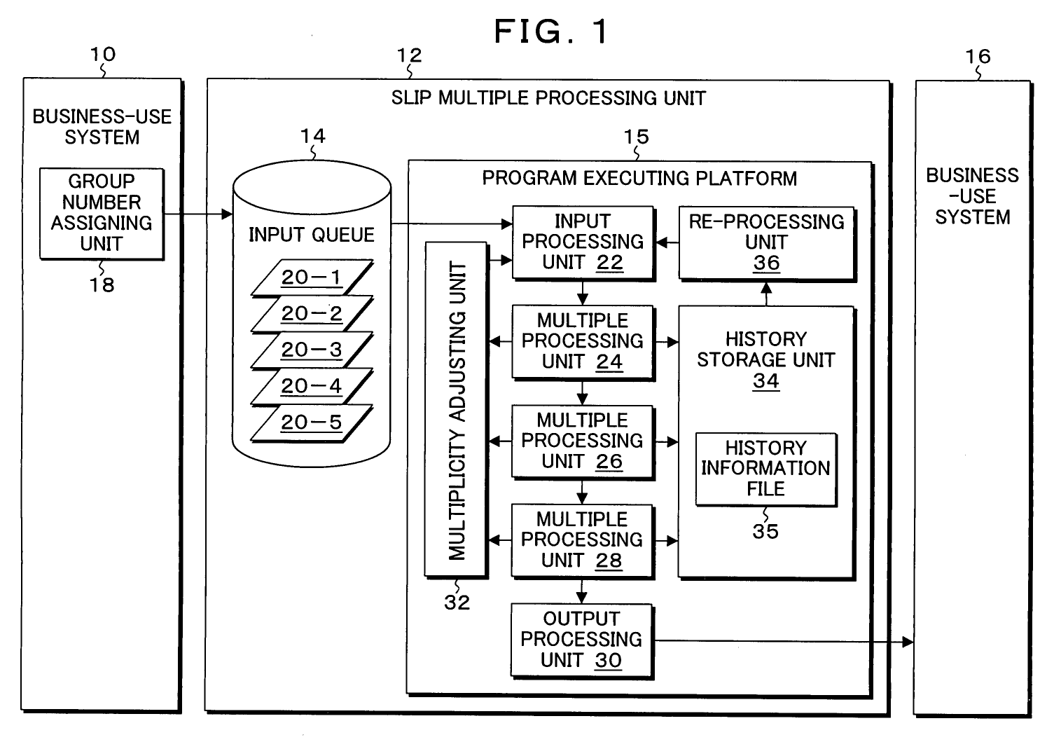

FIG. 1 shows a block diagram of a business-use system equipped with a slip multiple processing function of the invention. In FIG. 1, a slip multiple processing unit 12 is provided between a business-use system 10 and another business-use system 16. The slip multiple processing unit 12 is provided with an input queue 14 and a program executing platform 15. On the program executing platform 15, an input processing unit 22, multiple processing units 24, 26, 28 and an output processing unit 30 are provided. In addition, on the program executing platform 15, a history storage unit 34 equipped with a multiplicity level adjusting unit 32 and a history information file 35 for the multiple processing, and a re-processing unit are also provided. In this embodiment, the multiple processing unit is shown to have three (3) stages, however, the number of the stages can be set at one (1) or more arbitrary number.

The input queue 14 stores slips 20-1 to 2-5 from the business-use system. The input queue 14 has a storage structure that can hold the order of storing slips 20-1 to 20-5 and is, for example, a database capable of storing and outputting on a First-In-First-Out (FIFO) basis. The input processing unit 22 takes out the number of slips corresponding to the multiplicity level of business-related processing in the order of their input among the slips stored in the input queue 14, and assigns multiple processing management numbers i (i=1, 2, 3, 4, 5, . . . ) to the slips taken out such that the numbers are the serial numbers in the order of the slips taken out, thereafter, creates consolidated-format slips by consolidating the slips. Each of the multiple processing units 24, 26, 28 executes arbitrary business-related processes such as, for example, a modification process for slips, summation, storage of results or communication, executes in parallel the number of business-related processes corresponding to the multiple levels by dividing the consolidated-format slips accepted, into single slips, consolidates processed slips again into consolidated-format slips and outputs them. The output processing unit 30 divides the consolidated-format slips obtained from the last multiple processing unit 28 into single slips and outputs them to the business-use system 16 in the order of their input. The multiple level adjusting unit 32 adjusts the value of the multiple level based on the processing sufficiency rate at the multiple processing units 24, 26, 28 such that the number of executions of multiple processing is optimal. The history storage unit 34 stores in a history information file 35 history information containing unique numbers that each slip has, the multiple processing management numbers assigned in the input processing unit 22 and specific information for business-related processing when the first processing of slips at the multiple processing units 24, 26, 28 is executed. When any of the multiple processing unit 24, 26, 28 fails in processing a slip and returns the slip to the input processing unit 22, the re-processing unit 36 succeeds the specific information of the previous business-related processing by referring to the history information stored in the history information file 35 and executes the same process as the previous one based on the specific information of the business-related processing obtained from the history information as business-related processing executed in the multiple processing unit 24, 26 or 28. Furthermore, in the case where it is necessary that consolidated processing is executed by a group number assigning unit 18 provided on the side of the business-use system 10 without changing the process units for the related slips when a slip is inputted from the business-use system 10 into the input queue 14 of the slip multiple processing unit 12, a same group number is assigned to the slip and the slip is stored in the input queue 14. Then, a consolidated-format slip is created in the slip multiple processing unit 12 for each group number assigned on the side of the business-related system 10 as a unit. Thereby, improvement of the processing performance and assurance of the current state can be achieved. The program executing platform 15 starts up programs for realizing the functions of the input processing unit 22, the multiple processing units 24, 26, 28, the output processing unit 30, the multiplicity level adjusting unit 32, the history storage unit 34 and the re-processing unit 36 in this order and executes the general processing in which consolidated-format slips are sent and received one after another. Here, the slip multiple processing unit 12 of the invention is provided to each of the business operation lines that needs the assurance of the order of the slips. Therefore, only the related slips are inputted from the business-use system 10. Thereby, the slip multiple processing unit 12 has no need to determine whether or not it can process the inputted slips based on the relations they have with other slips issued by the business-related system 10, and can multiple-process the same processes. Thereby, improvement of the performance of processing slips and assurance of the order can be both achieved.

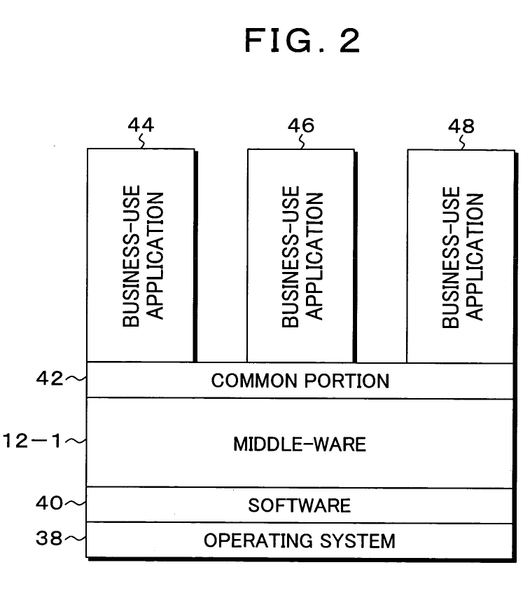

FIG. 2 illustrates a program execution environment equipped with a slip multiple processing unit of the invention as middle-ware. In FIG. 2, the program execution environment realizing the slip multiple processing function of the invention is as follows. Software 40 is disposed on an OS 38 on which middle-ware 12-1 functioning as the slip multiple processing unit 12 in FIG. 1 is disposed. On the middle-ware 12-1, a common portion 42 is disposed and, on the common portion 42, business-use applications 44, 46, 48 executing respective multiple processing are disposed. As is clear from the program execution environment employing the slip multiple processing unit 12 as the middle-ware 12-1, the multiple processing unit 12 of the invention is not dependent on any of the specific business-use application 44, 46, 48 and is for general-purpose use.

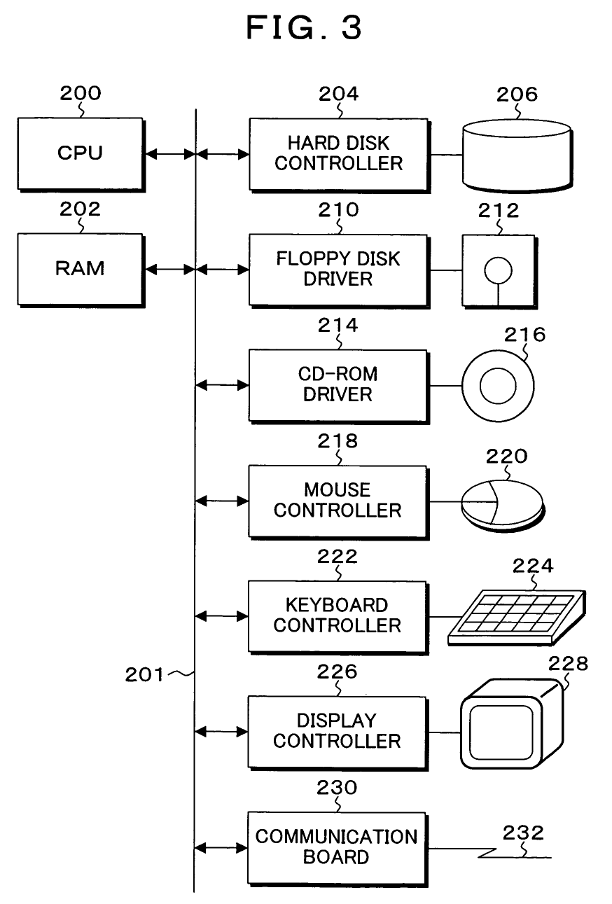

FIG. 3 illustrates a hardware environment of a computer executing a program for the slip multiple processing of the invention. In the computer in FIG. 3, a bus 201 of a CPU 200 is connected with an RAM 202, a hard disk controller (software) 204, a floppy disk driver (software) 210, a CD-ROM driver (software) 214, a mouse controller 218, a keyboard controller 222, a display controller 226 and a communication board 230. The hard disk controller 204 is connected with a hard disk drive 206, is loaded with a program executing the slip multiple processing of the invention and, when the computer starts up, call necessary programs from the hard disk drive 206, develops it on the RAM 202 and executes it with the CPU 200. The floppy disk driver 210 is connected with a floppy disk drive (hardware) 212, and reading from and writing into a floppy disk (R) can be executed. The CD-ROM driver 214 is connected with a CD drive (hardware) 216 and can read data and programs stored in a CD. The mouse controller 218 transmits input operations on a mouse 220 to the CPU 200. The keyboard controller 222 transmits input operations on a keyboard 224 to the CPU 200. The display controller 226 causes a display unit 128 to display. The communication board 230 communicates with apparatuses within a network and external apparatuses on the Internet by using a communication line 232 including a wireless line.

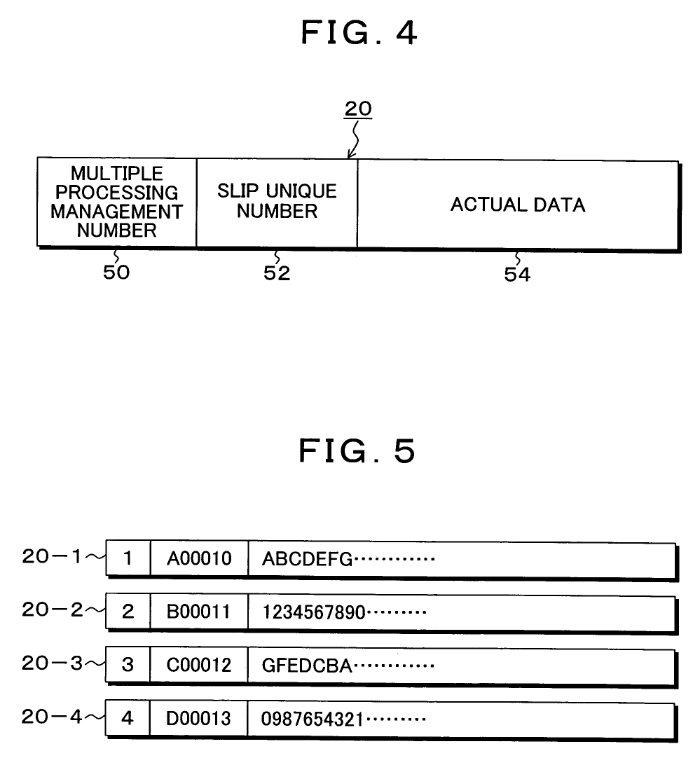

FIG. 4 illustrates a format of a slip assigned with a multiple processing management number by the input processing unit 22 provided on the slip multiple processing unit 12 shown in FIG. 1. In FIG. 4, a slip 20 comprises a multiple processing management number 50, a slip unique number 52 and actual data 54.

FIG. 5 illustrates a specific example of a plurality of slips assigned with multiple processing management numbers by retrieving for the multiple processing by the input processing unit 22 of the slip multiple processing unit 12 in FIG. 1. In FIG. 5, four (4) slips 20-1, 20-2, 20-3 and 20-4 are retrieved from the business-use system 10 in the order of their input and serial numbers of i=1, 2, 3, 4 are assigned to them as the multiple processing management numbers 50 at the head of the format for the slip 20 shown in FIG. 4. To each of the slips 20-1 to 20-4, when they are issued from the business-use system, “A00010”, “B000111”, “C00012” and “D00013” are assigned as the slip unique numbers 52.

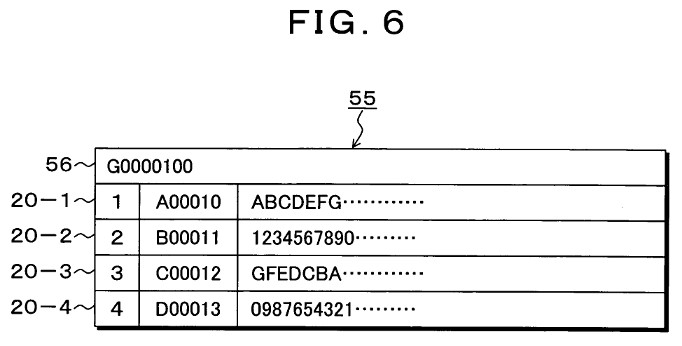

FIG. 6 illustrates a consolidated-format slip 55 produced by consolidating the slips 20-1 to 20-4 in FIG. 5. The consolidated-format slip 55 is produced with the limitation of the number of the multiplicity level M. For example, when the multiplicity level M is M=4, the consolidated-format slip 55 has a slip structure produced by consolidating the four (4) slips 20-1 to 20-4 as shown in FIG. 6. The relations between the slips 20-1 to 20-4 in the consolidated-format slip 55 are retained in a pointer and, thereby, the time necessary for consolidating of slips and dividing of consolidated-format slips is very short. Furthermore, in the slip 20 shown in FIG. 4, the multiple processing management number 50, the slip unique number 52 and the actual data 54 are shown as the basic information items for consolidating slips into the consolidated-format slip 55. However, in addition to them, the actual data lengths and additional information as necessary can be included. The consolidated-format slip 55 is further provided with a group number 56. The group number 56 is assigned only in the case where the input processing unit 22 produces a consolidated-format slip by consolidating slips having the same group number when the business-use system assigns a group number to each slip and stores it in the input queue 14 in order to causes it to be processed being consolidated. The consolidated-format slip 55 shown in FIG. 6 produced in this manner is retained in a memory of a process realizing the program executing platform 15 shown in FIG. 1 or is stored in a queue of a magnetic disk.

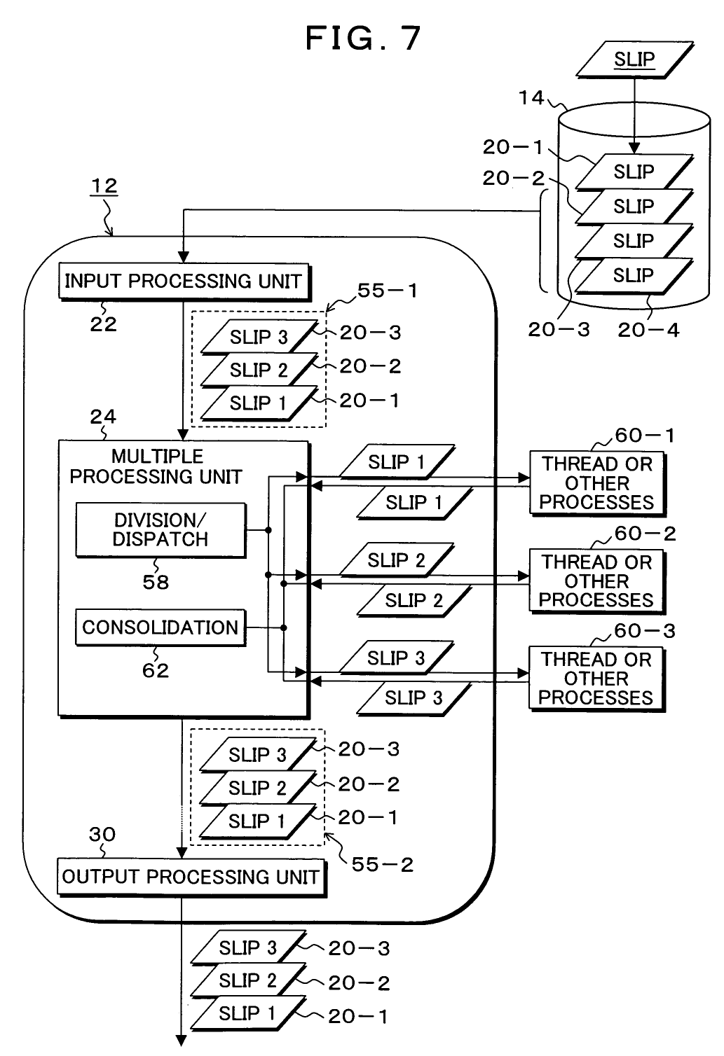

FIG. 7 is a diagram showing schematically the slip multiple processing according to the invention shown in FIG. 1. In FIG. 7, the business-use system 10 stores a slip in the input queue 14 in the order of processing of slips. In this example, four (4) slips 20-1 to 20-4 are stored in the input queue. Each of the slips 20-1 to 20-4 is assigned with a unique number that can be identified uniquely. However, when a slip has no unique number, a unique number is assigned to it when it is stored in the input queue 14. The input processing unit 22 takes out the slips 20-1 to 20-4 currently stored in the input queue 14 in the order of their age with the limitation of a predetermined multiplicity level M, assigns a multiple processing management number i (i=1, 2, 3, . . . ) to each of the slips such that the number is serial number according to the order a slip has been taken out, and consolidates them into a consolidated-format slip 55-1. In this example, the multiplicity level M is set as M=3, and the input processing unit 22 takes out the slips 20-1, 20-2, 20-3 from the input queue 14 in the order of their age and assigns multiple processing management numbers 1, 2, 3 to them respectively in the order in which they have been taken out and, thereafter, produces the consolidated-format slip 55-1 by consolidating the slips. Multiple processing by the multiple processing units 24, 26, 28 is executed from the input processing unit 22 to the output processing unit 30 in the program executing platform 15. However, in this example, only the multiple processing unit 24 is exemplified. The multiple processing unit 24 executes arbitrary processes such as modification of slips, communication and storage of process history. When the process of the multiple processing unit 24 has completed, the program executing platform 15 takes out a consolidated-format slip from it and delivers the slip to the next multiple processing unit 26. The multiple processing unit 24 takes out single slips by dividing the slip of the consolidated-format slip 55-1 using a function of division/dispatch 58, assigns each of the single slips to a thread or other processes 60-1, 60-2, 60-3 and call the processes. This process may be a remotely called program for another system. The slips are modified by this multiple processing and the process result is returned. However, there is a case where the slips are not modified and are returned as they are. The returned slips are consolidated into a consolidated-format slip 55-2 using the function of consolidation 62 and it is delivered to the next multiple processing unit. The output processing unit 30 receives and divides the consolidated-format slip for which the process of the last multiple processing unit has been completed, and delivers the divided slips 20-1, 20-2, 20-3 to the business-use system 16. The slips 20-1, 20-2, 20-3 in this case are delivered in the order of the multiple processing management numbers 1, 2, 3. The scheme of outputting the slips by the output processing unit 30 may be the one by file transfer or storage to a output queue as in the case for inputting. When the output process by the output processing unit 30 has been completed, the input processing unit 22 take back the control and repeats the process. For the slip multiple processing unit of the invention, a composition, having no output processing unit 30, in which slips are stored in the last multiple processing unit is possible and, in the case where there is no output process, the control returns to the input processing unit 22 when the last multiple processing has been completed. As described above, in the slip multiple processing of the invention, regardless of the slip formats, in order to multiple-process these formats at a time one by one, a simple mechanism is employed and, therefore, it can be arranged for general purpose. Furthermore, by executing multiple processing, the two tasks inconsistent with each other that processing performance can be improved and, simultaneously, the assurance of the order of slips can be solved.

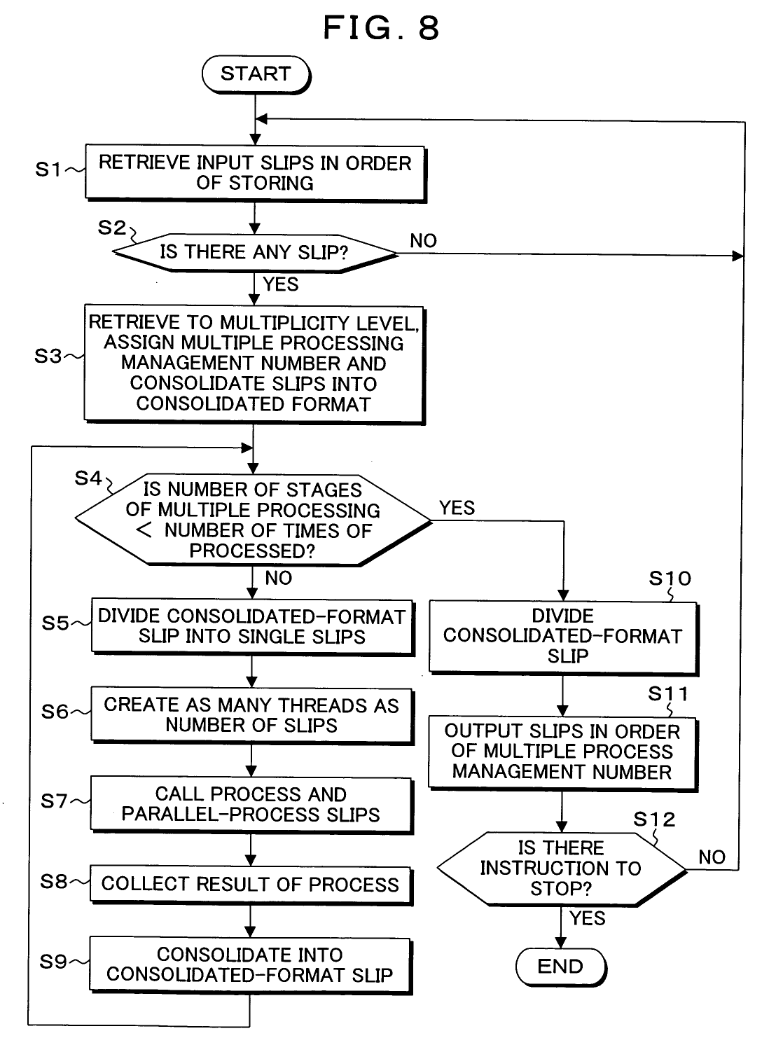

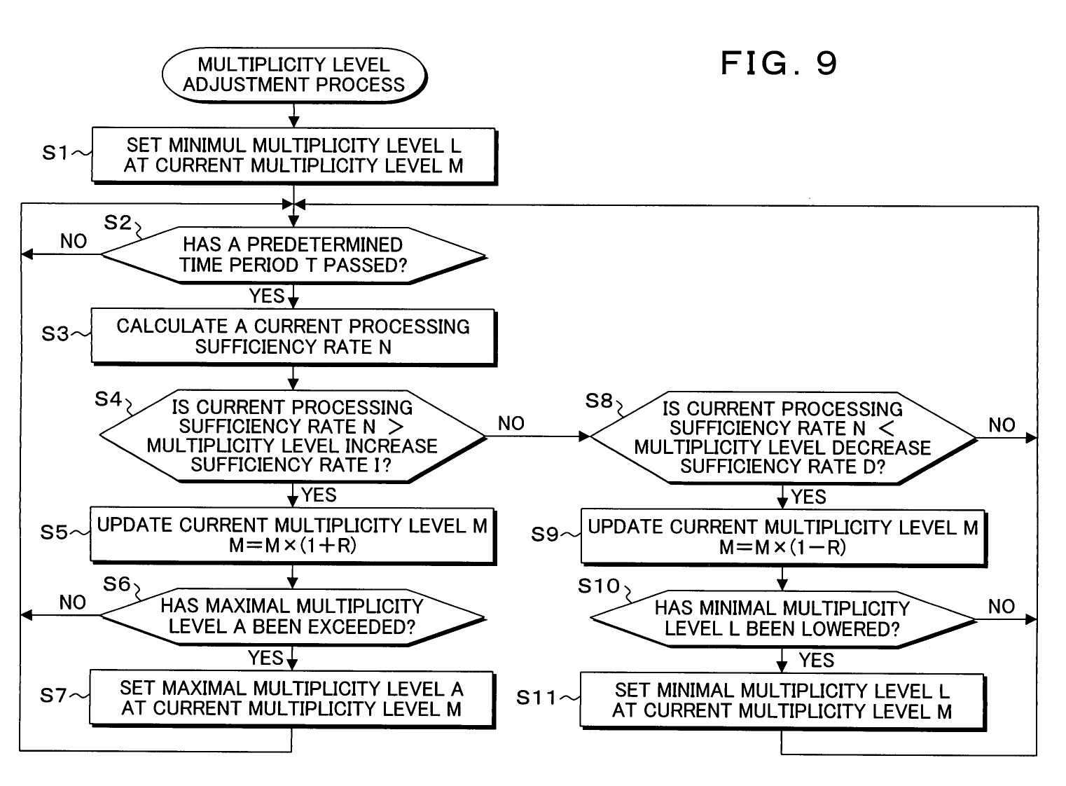

FIG. 8 is a flowchart showing the slip multiple processing according to the invention. In FIG. 8, in Step S1, slips stored in the input queue 14 are retrieved by the input processing unit 22 in the order of their storage. In Step S2, when it is determined that there are a slips, the process proceeds to Step S3. In Step S3, the slips are retrieved to the number of the multiplicity level, multiple processing numbers are assigned to the retrieved slips one after another and single slips are consolidated into a consolidated-form slip. Then, in Step S4, the number of stages of the multiple processing and the number of times of processing are compared with each other and, when the number of times of processing is smaller than the number of stages of the multiple processing, the process proceeds to Step S5. In the case shown in FIG. 1, the number of stages of the multiple processing is three (3). Then, the processes after Step S5 are repeated until the number of times of processing reaches three. Step S5 is the process executed by the first multiple processing unit 24, in which the consolidated-format slip is divided into single slips. In Step S6, as many threads as the slips are created. In Step S7, a process is called and each slip is processed in parallel. In Step S8, process results are collected. In Step S9, the slips are consolidated into a consolidated-format slip and, thereafter, it is delivered to the next multiple processing. After repeating the processes in these steps Step S4 to S9 until the number of stages of the multiple processing reaches the number of times of processing, the process proceeds to Step S10 in which the consolidated-format slip is divided by the output processing unit 30. Then, in Step S11, the divided slip is outputted to the business-use system 16 being the destination in the order of the multiple processing management number. In Step S12, whether or not there is an instruction to stop the process is checked, and the process is repeated from Step S1 until there is an instruction to stop it.

FIG. 9 is a flowchart of a multiplicity level adjustment process according to the invention. The value of the multiplicity in the invention relates to the number of slips taken out from the input queue 14, the number of slips delivered from the input processing unit 22 to the output processing unit 30, and the number of programs called in parallel in the multiple processing units 24, 26, 28. In the input processing unit 22, a consolidated-format slip is produced by taking out the slips with the limitation of a specified multiplicity level and, in the case where the number of the slips is smaller than the multiplicity level when the retrieval is completed, the process is executed only to the retrieved slips. Therefore, in the multiple processing using a consolidated-format slip, there are cases where multiple processing exhausting completely the multiplicity level at that time is executed or where multiple processing is executed in a state where the multiplicity level is excessive when the number of slips is smaller than the value of the multiplicity level. In the multiplicity level adjusting process shown in FIG. 9, a parameter of the process sufficiency rate is used. The process sufficiency rate is a rate of multiple processing processed exhausting completely the multiplicity level. That is, the processing sufficiency rate can be said to be the rate of the number of times of multiple processing for slips satisfying the current multiplicity level, to the number of times of multiple processing per unit time period. For example, assuming that the current multiplicity level M is M=3, that ten (10) times of processing is executed within a unit time period T, of which four (4) times of processing is a process consolidating three (3) slips that have exhausted completely the multiplicity level, and the rest is a process for two (2) slips or less, the processing sufficiency rate N in this case is N=0.4. Then, when the value of the processing sufficiency rate N is larger than a predetermined threshold value of the increase sufficiency rate or when it is smaller than a threshold value of the decrease sufficiency rate, the multiplicity level is varied by a predetermined increment or a predetermined decrement. When no threshold value of the increase sufficiency rate or the decrease sufficiency rate is specified, adjustment of the multiplicity level is not executed. Then, the description of the flowchart of the multiplicity level adjustment process shown in FIG. 9 is as follows. In Step S1, a multiplicity level L is set at the current multiplicity level M. Then, in Step S2, the progress within a predetermined time period T is checked and, when the predetermined time period T has passed, the process proceeds to Step S3 in which the current processing sufficiency rate N is calculated. In Step S4, whether or not the current processing sufficiency rate N is larger than the multiplicity level increase sufficiency rate “I” is checked and, when it is so, the process proceeds to Step S5 in which the current multiplicity level M is updated. In this update, the current multiplicity level M is multiplied by (1+R) and an increased multiplicity level M is obtained. Here, R is a value used as an increment or a decrement of the multiplicity level. Surely, the calculated value is an integer value. Next, in Step S6, whether or not the multiplicity level M after being updated is larger than the maximal multiplicity level “A” is checked and, when it is not, the process returns to Step S2 and, when it is, the value of the maximal multiplicity level “AA” is set at the value of the current multiplicity level M in Step S7. On the other hand, when the current processing sufficiency rate N is not larger than the multiplicity level increase sufficiency rate “I” in Step S4, the process proceeds to Step S8 in which whether or not the current processing sufficiency rate N is smaller than the multiplicity level decrease sufficiency rate D is checked. When it is smaller than the multiplicity level decrease sufficiency rate D, the process proceeds to Step S9 in which the current multiplicity level M is updated. The calculated value for this updating is obtained by multiplying the current multiplicity level M by a coefficient (1−R). Then, in Step S10, whether or not the updated current multiplicity level M is smaller than the minimal multiplicity level L is checked and, when it is not, the process returns to Step S2 and, when it is, the process proceeds to Step S11 in which the value of the minimal multiplicity level L is set at the value of the current multiplicity level M. By the adjustment process of the multiplicity level as described above, it is possible to adjust automatically the multiplicity level to an optimal value in response to the amount of slips for each slip processing line for which the order is assured and, when the processing sufficiency rate becomes high, the processing performance is improved by increasing the multiplicity level while, when the processing sufficiency rate becomes low, the resources are saved by decreasing the number of parallel processes by decreasing the multiplicity level.

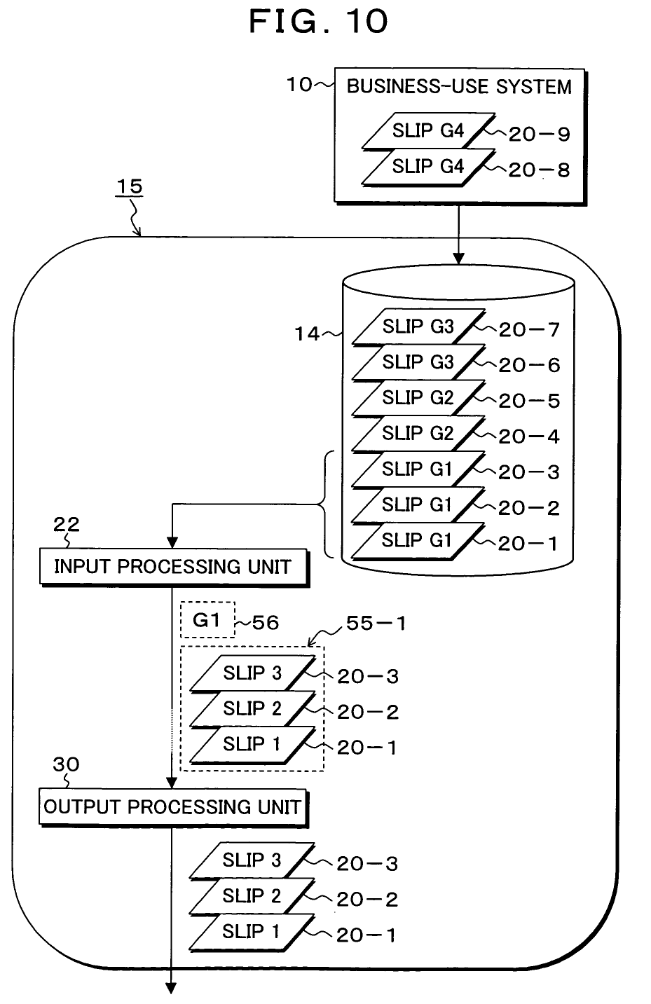

FIG. 10 illustrates schematically the slip multiple processing of the invention targeting slips assigned with group numbers. In the slip multiple processing, when slips having relations with each other for business operation are desired to be processed in a batch maintaining the processing unit of the slips, a group number Gi is assigned to each of the slips from the business-use system 10 and the slips are stored in the input queue 14. In this example, in the input queue 14, the slips 20-1 to 20-3 having the same group number G1 are stored and the slips 20-4, 20-5 having a group number G2 are also stored and the slips 20-6, 20-7 having a group number G3 are further stored. The input processing unit 22 retrieves the slips in the input queue 14 from the oldest slip one after another. However, when a group numbers is assigned to a slip retrieved, a consolidated-format slip is produced by consolidating other slips by taking out them in the order of their storage based on the group number. For example, assuming that the input processing unit 22 has retrieved the slip 20-1 as the oldest slip in the input queue 14, the slip 20-1 has the group number G1 and, therefore, the slips 20-2, 20-3 having the same group number G1 are retrieved using the group number G1. Then, the slips 20-1 to 20-3 having the retrieved same group number G1 are consolidated and, thereby, the consolidated-format slip 55-1 is produced and is delivered to the next multiple processing unit 24. Surely, the number of slips that can be consolidated by the input processing unit 22 as the consolidated-format slip 55-1 is within the multiple level at that time. The consolidated-format slip in this case is assigned with the group number 56 in the consolidated-format slip 55 shown in FIG. 6. Since the group number G1 is assigned to the consolidated-format slip 55-1 and is succeeded among the multiple processing units, it is possible to succeed the processing unit of slips by delivering the group number G1 from the output processing unit 30 to the business-use system.

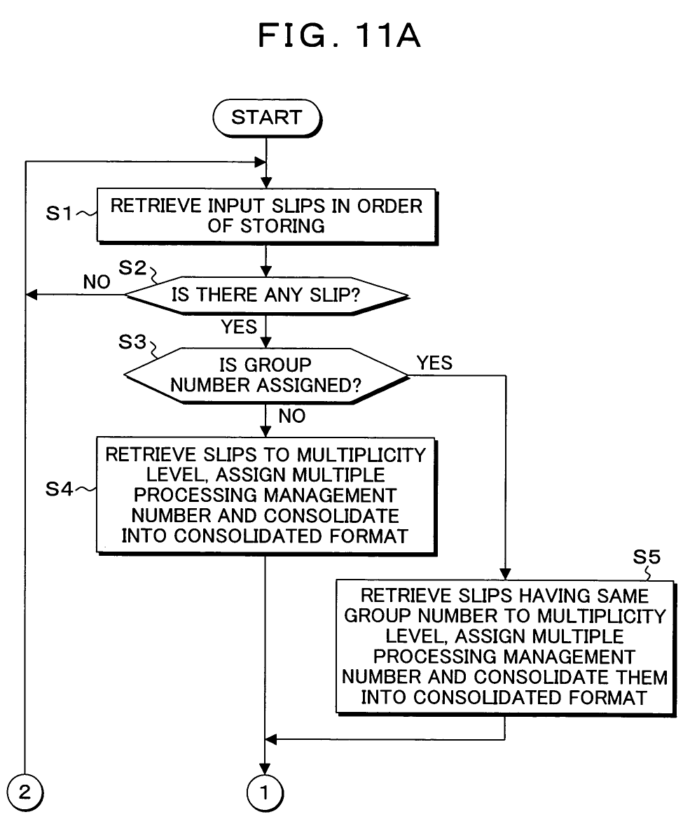

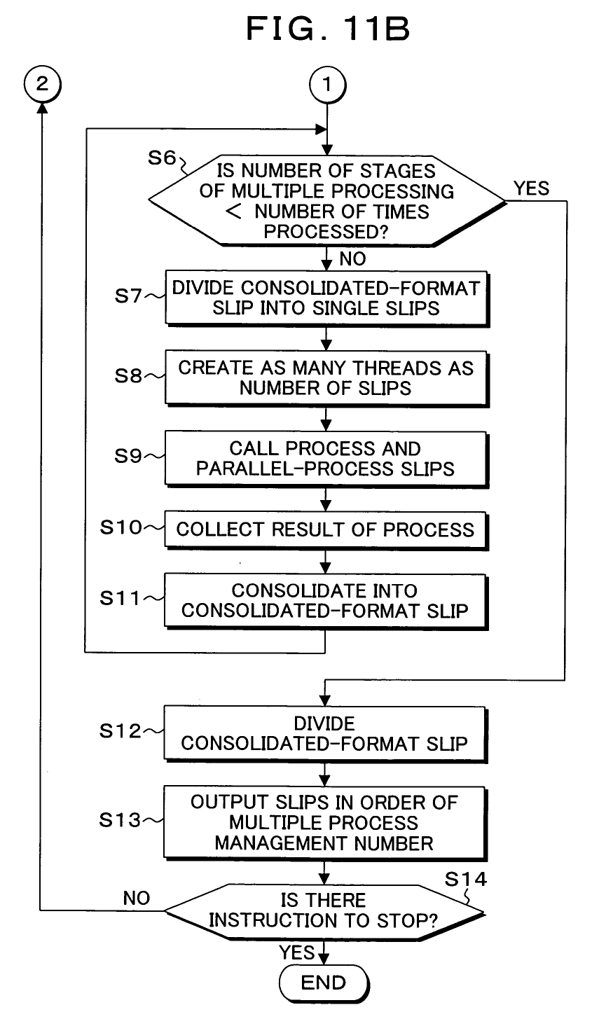

FIGS. 11A and 11B together show a flowchart of the slip multiple processing of the invention including a process targeting slips assigned with group numbers in FIG. 10. In FIGS. 11A and 11B, in Step S1, input slips are retrieved in the order of their storage. When there is a slip in Step S2, whether or not there is a group number is checked in Step S3. When there is a group number, the process proceeds to Step S5 in which slips having the same group number are retrieved in the order of their age up to the multiplicity level, are assigned with multiplicity level management numbers and are consolidated into a consolidated format. On the other hand, when there is no group number, in Step S4, slips are retrieved up to the multiplicity level, are assigned with multiplicity level management number and are consolidated into a consolidated format. Processes in Step S6 to S14 are same as those in Step S4 to S12 shown in FIG. 8.

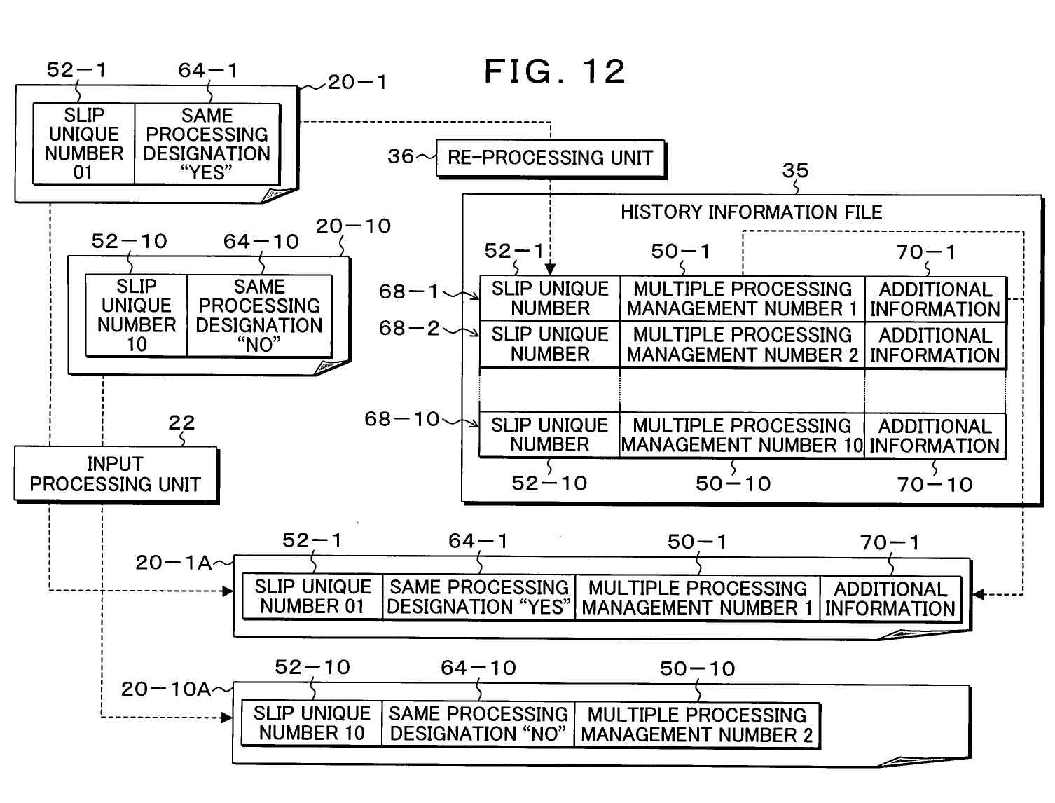

FIG. 12 illustrates an input process when executing re-processing utilizing history information stored in the first slip processing. During the execution of the first multiple processing executed after consolidating into a consolidated-format slip, history information is stored in the history information file 35 by the history storage unit 34. History information 68-1, 68-2, . . . , 68-10 is stored in the history information file 35. For example, referring to the history information 68-1, it contains a slip unique number 52-1, a multiple processing management number 50-1 and additional information 70-1 specific to the business-related processing are stored. Here, the addition information 70-1 is information specific to the first business-related processing and threads and processes in the first multiple processing can be recognized by referring to this additional information 70-1. In FIG. 12, the slip 20-1 is an input slip for re-execution and it is provided with a same processing designation 64-1 in addition to the slip unique number 52-1, and this same processing designation 64-1 is designated to “Yet”. The input processing unit 22 retrieves the slip 20-1 being such a re-execution target and assigns the multiple processing management number 50-1 as shown on a slip 20-1A. At the same time, the re-processing unit 36 retrieves the history information file 35 using the slip unique number 52-1 based on the same processing designation 64-1 of the slip 20-1 and retrieves the history information 68-1 obtained in the previous processing. Then, the additional information 70-1 stored in this history information 68-1 is taken out. Then, the slip 20-1A assigned with the multiple processing management number 50-1 in the input processing unit 22 is added with the additional information 70-1 and is delivered. The additional information 70-1 stores information specific to the business-related processing, i.e., information relating to threads and processes in the first multiple processing and, thereby, the slip 20-1 to be re-executed can be re-processed with the same processing serial number as the previous one by delivering it to the same threads or processes as those in the previous processing and by selecting the same communication paths. On the other hand, as for another target slip 20-10 of re-execution, because the same processing designation 64-10 is designated to “No”, in this case, the input processing unit 22 retrieves without referring to the history information file 35, assigns the multiple processing management number 50-10 as shown on the slip 20-10A, consolidates into a consolidated-file format and delivers it to the multiple processing. When the input processing unit 22 refers to the history information file 35 during the taking out of slips from the input queue 14, in the case where a plurality of slips have the same multiple processing management number, the input processing unit 22 is arranged not to take out the slips other than the one for the first processing and to take out the slips to be re-executed in the next processing. Thereby, even in the case where the multiple processing management number of a slip for the first processing and that of a slip to be re-executed are same, processing of the slip for the first processing can be given priority.

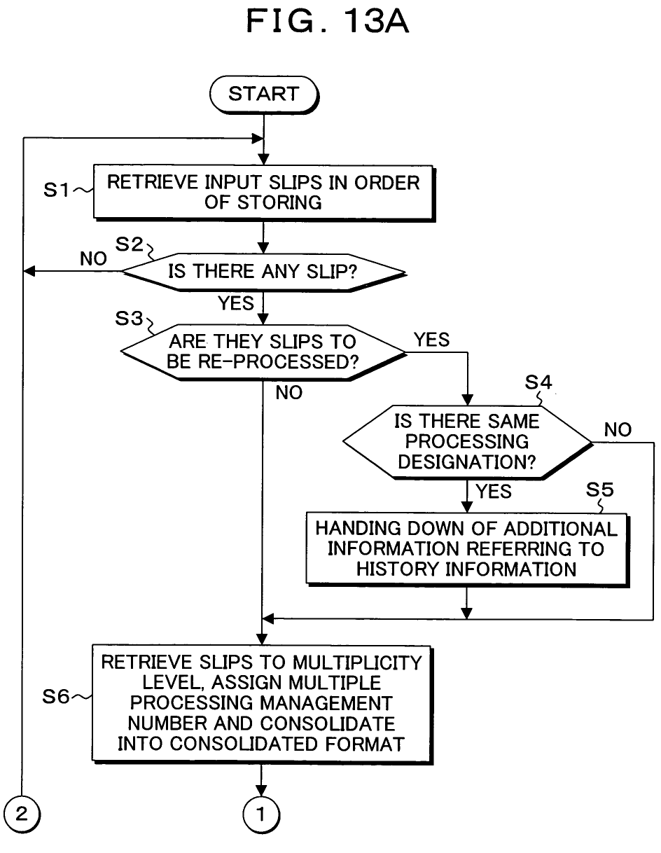

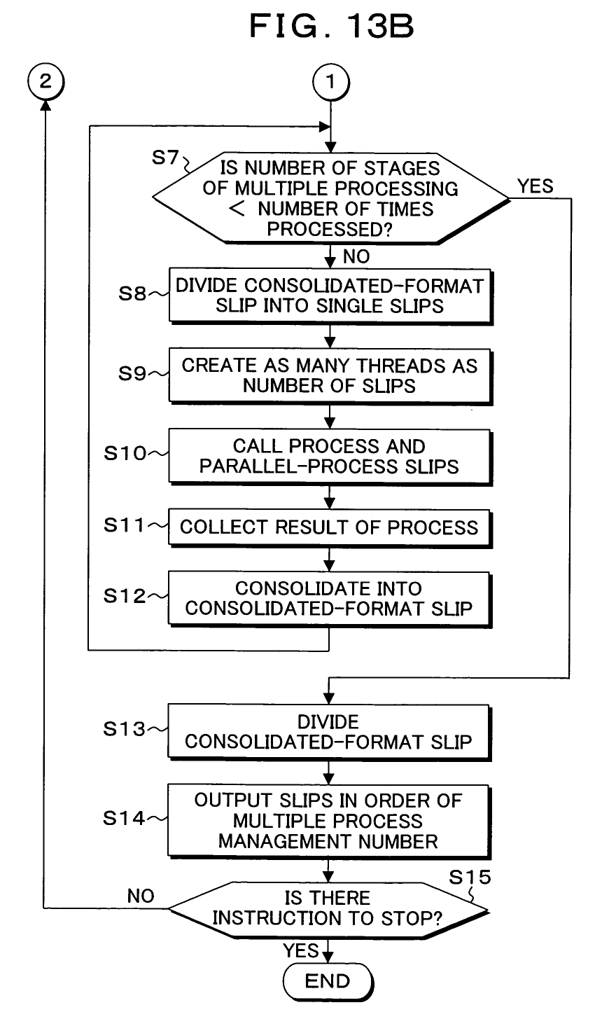

FIGS. 13A and 13B together show a flowchart of slip multiple processing of the invention including re-processing by reference of the history information in FIG. 12. In FIGS. 13A and 13B, in Step S1, input slips are retrieved in the order of their storage. When it is determined that there is a slip in Step S2, the process proceeds to Step S3 in which whether or not it is a slip to be re-processed is checked. When it is a slip to be re-processed, in Step S4, whether or not there is any designation to execute the same process to the slip to be re-processed is checked and, when there is, the process proceeds to Step S5 in which additional information is succeeded by referring to the history information. Then, in Step S6, slips are retrieved up to the multiplicity level, are assigned with multiplicity level management numbers and are consolidated into a consolidated-format. Step S7 to Step S15 are same as Step S4 to S12 shown in FIG. 8.

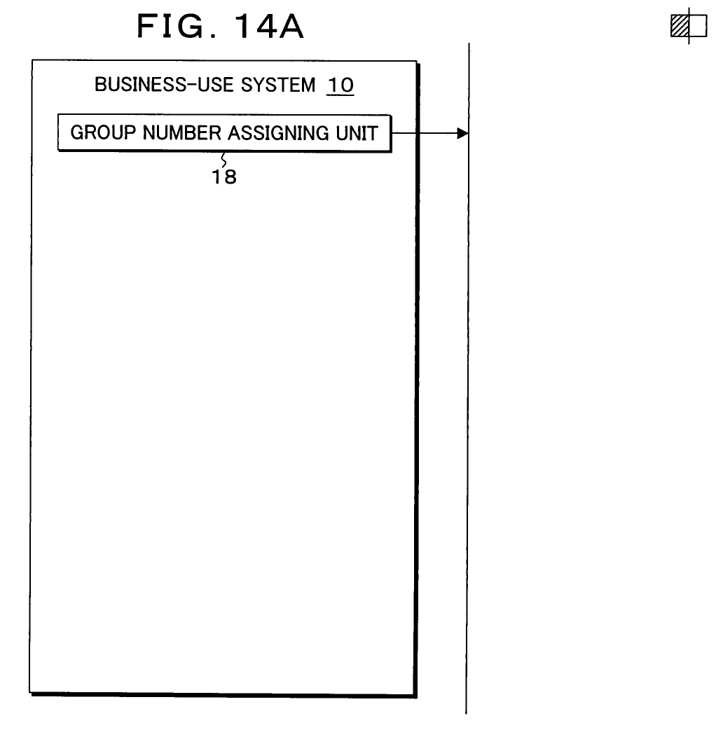

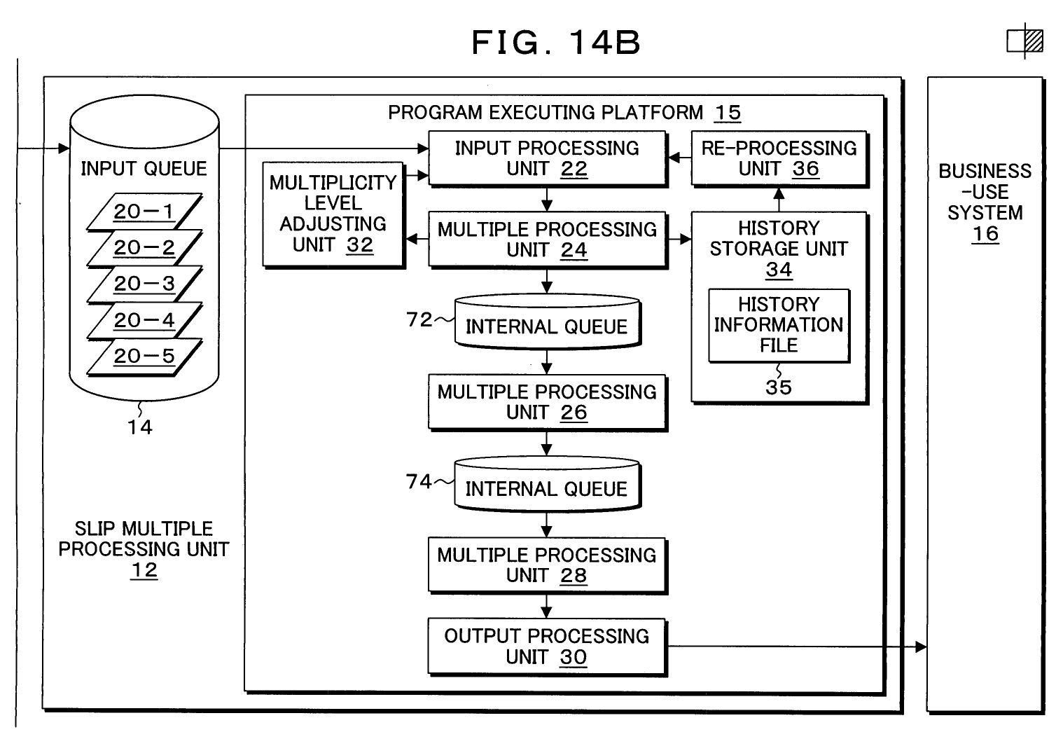

FIGS. 14A and 14B are block diagrams of the slip multiple processing of the invention that improves the efficiency of re-processing by storing consolidated-format slips in an internal queue. In FIGS. 14A and 14B, the slip multiple processing unit 12 of this embodiment is disposed with an internal queue 72 between the multiple processing unit 24, 26, 28 provided on the program executing platform 15. The internal queue 72 stores a consolidated-format slip obtained as the processing result of the multiple processing unit 24. Therefore, the multiple processing unit 26 started up in response to receiving the succession of the process, retrieves the internal queue 72 and takes in the consolidated-format slip to be processed newly. As for the consolidated-format slip obtained as a result of the processing by the multiple processing unit 26, it is delivered to the multiple processing unit 28 after being stored in the internal queue 74. As described above, by preserving the consolidated-format slips delivered during the multiple processing with the internal queues 72, 74 disposed between the multiple processing units 24, 26, 28, when any of the multiple processing units fails to process a consolidated-format slip, it is possible to take out the consolidated-format slip from the internal queue provided to a stage immediately before the multiple processing unit that has failed to process it and to re-process it without returning to the input processing unit 22 at the head. Furthermore, for storage and erasing of the consolidated-format slip to the internal queue 72, 74, it is erased synchronizing with the storage to the internal queue positioned at the previous stage.

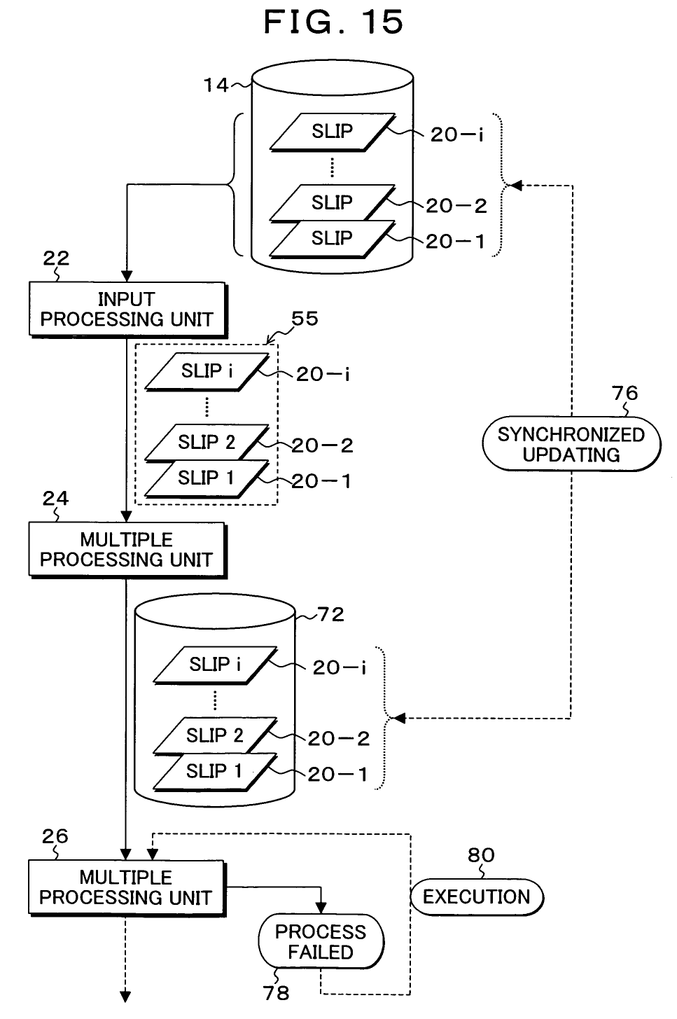

FIG. 15 illustrates transfer of slips to the internal queue in FIGS. 14A and 14B and re-execution when the process has failed. In FIG. 15, the slips 20-1 to 20-i stored in the internal queue 14 are retrieved by the input processing unit 22 with the limitation of the multiplicity level, are assigned with multiple processing management numbers 1, 2, . . . , i and are consolidated. Thereby, the consolidated-format slip 55 is produced and is delivered to the multiple processing unit 24. The multiple processing unit 24 separates the consolidated-format slip 55 and executes in parallel each respective business-related processing for each slip corresponding to its multiplicity level. Thereafter, the slips as a result of the processing are consolidated again into a consolidated-format slip and this processing result is stored in the internal queue 72. When the slips 20-1 to 20-i has been stored in this internal queue 72, the slips 20-1 to 20-i having been processed and stored in the input queue 14 positioned at the previous stage are erased by the process of a synchronized updating 76. Then, the control is delivered to the multiple processing unit 26 and the multiple processing unit 26 takes out the consolidated-format slip containing the slips 20-1 to 20-i from the internal queue 72, divides it and executes multiple processing for each slip. When process failure 78 occurs in this multiple processing, the multiple processing unit 26, as re-execution 80, again takes in the consolidated-format slip containing the slips 20-1 to 20-i from the internal queue 72 and executes re-processing. Therefore, the re-execution can be executed at a high speed when the processing has failed because it is not necessary to return the process to the input queue 14. According to the synchronized updating 76 in which erasing of the slips of the input queue 14 with the storage into the internal queue 72 is executed, synchronized update is executed using the slip unique numbers assigned to slips as the key. Furthermore, it is desirable that the input queue 14 and the internal queue 72 are databases easy to commit simultaneously.

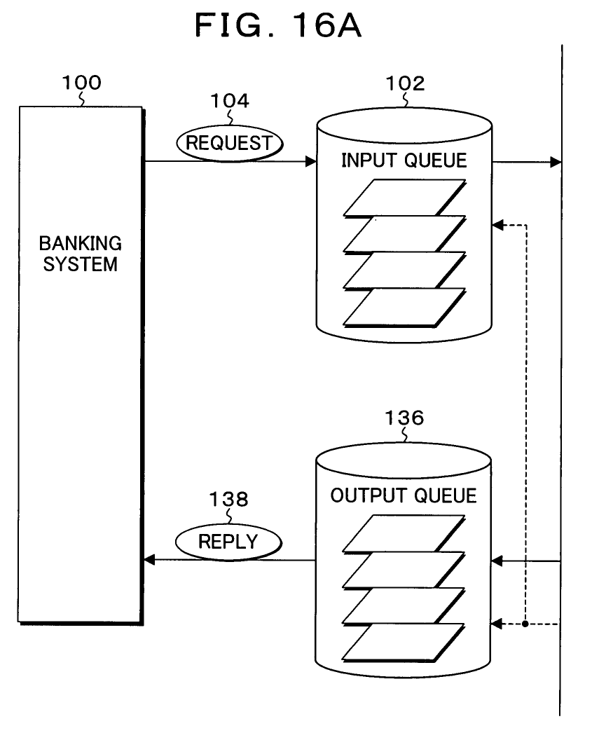

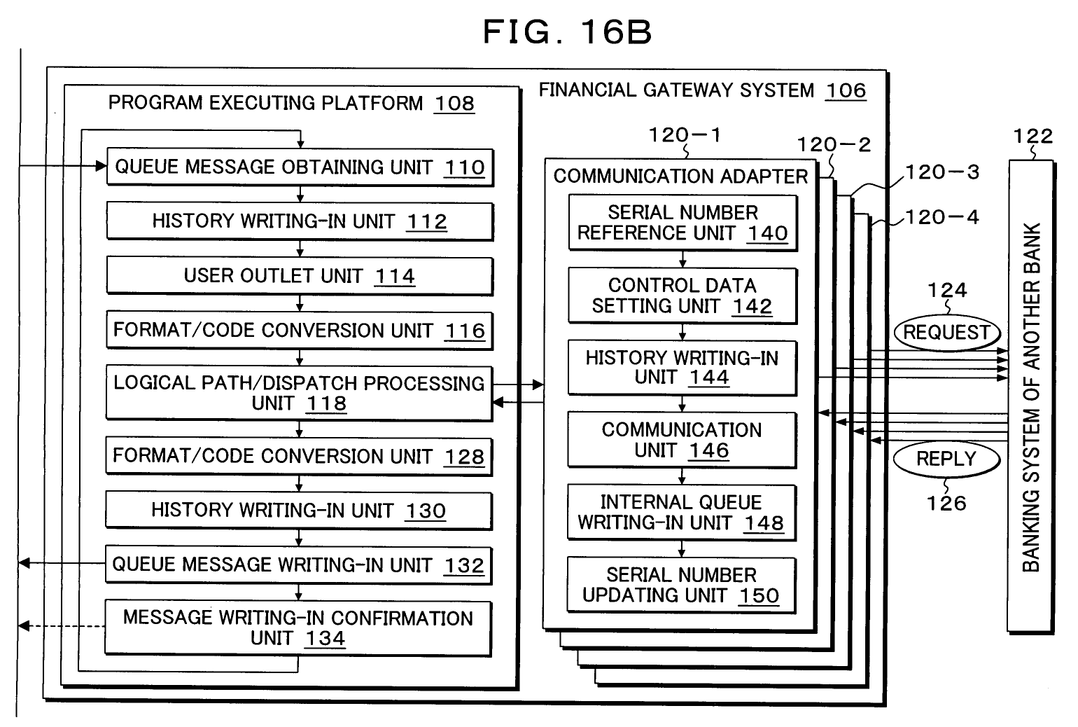

FIGS. 16A and 16B show block diagrams of functional composition when the slip multiple processing of the invention is applied to a financial gateway system between banking systems. In FIGS. 16A and 16B, a financial gateway system 106 equipped with the multiple processing function of the invention, is disposed between a banking-use system 100 and a banking-use system 122 of another bank. Slips from the banking-use system 100 are stored into the input queue 102 as a request 104. The financial gateway system 106 is provided, on its program executing platform 108, with the queue message obtaining unit 110 functioning as an input processing unit of the invention, a history writing-in unit 112 functioning as a multiple processing unit of the invention, user outlet unit 114, format/code conversion unit 116. A logical path/dispatch processing unit 118 provided after them corresponds to target processing executing communication processing, and as many communication adapters 120-1 to 120-4 as the number of the multiplicity level are provided corresponding to that. As shown being represented by the communication adapter 120-1, the communication adapters 120-1 to 120-4 are provided with a serial number reference unit 140, a control data setting unit 142, a history writing-in unit 144, a communication unit 146, an internal queue writing-in unit and a serial number updating unit 150. The communication adapters 120-1 to 120-4 forms respectively as many communication paths as the number of the communication adapters between the banking systems 122 of other banks, issues slips, send them to the banking systems 122 of other banks and receives the processing results as replies 126. The processing results of the communication adapters 120-1 to 120-4 are consolidated in the logical path/dispatch processing unit 118, undergo the processes in the format/code conversion unit 128, history writing-in unit 130, a queue message writing-in unit 132 and a message writing-in establishing unit 134 as a consolidated-format slip, and are stored from the queue message writing-in unit 132 into an output queue 136. Thereafter, they are sent to the banking system 100 as the replies 138. In the slip processing targeting the processes executed between banking systems as described above, the financial gateway system 106 executing the cooperation between banks in a communication protocol arranged in the financial industry has been constructed. In the communication processing by the financial gateway system 106, a specific protocol is employed and the types of operation with a large amount of data provides virtual communication paths at the application level and controls them for each of upward links and downward links in order to enable multiple communication. Therefore, the financial gateway system 106 applied with the invention as shown in FIGS. 16A and 16B is disposed for each type of operation. In the financial gateway system 106, in addition to the communication executed in a predetermined protocol, arbitrary processes such as format conversion and character code conversion for executing cooperation at the operation level, processing history storage and checking are necessary. In the communication processing, multiple communication is executed to cope with the increase of the data amount. However, it is also necessary to execute multiple processing in the series of arbitrary processes at the application level in order to improve the processing performance of all the systems cooperating as a whole and, during these processes, it is necessary to assure the processing order of slips. The description of the processing executed in the financial gateway system 106 shown in FIGS. 16A and 16B applied between banking systems as described above is as follows. In the banking system 100, slips to be processed are grouped for each operation type and are stored in the input queue 102 as requests 104. The queue message obtaining unit 110 provided in the program executing platform 108 of the financial gateway system 106 retrieves slips in the input queue 102 at a constant time interval, takes out them in the order of their age, assigns multiple processing management numbers to them, consolidates the slips taken out up to the limitation of the multiplicity level into a consolidated-format slip, and transfers it to the history writing-in unit 112 or any one of components after it. In the history writing-in unit 112, the user outlet unit 114, and the format/code conversion unit 116, the received consolidated-format slip is separated each time when the control is delivered and multiple-process the separated slips by thread calling being the parallel function calling for each single slip. The processing results are again consolidated and are delivered to the next process as a consolidated-format slip. The logical path/dispatch processing unit 118 separates the consolidated-format slip received from the format/code conversion unit 116 and delivers the separated slips to the communication adapters 120-1 to 120-4 created corresponding to the number of slips. In the communication adapters 120-1 to 120-4, for each slip, as shown in the communication adapter 120-1, after executing the processes by the serial number reference unit 140, the control data setting unit 142 and the history writing-in unit 144, communication is executed with the banking systems 122 of other banks through a plurality of paths using parallel process calling (load balance) in the communication unit 146. Slips obtained as the replies 126 from the banking systems 122 of other banks are returned, as the processing results, to the logical path/dispatch processing unit 118 of the program executing platform 108 through the processing of the internal queue writing-in unit 148 and the serial number updating unit 150, are consolidated into a consolidated-form slip and are delivered to the format/code conversion unit 128. Thereafter, by the processing of the history writing-in unit 130 and the queue message writing-in unit 132, the slip is separated slips and stored into the output queue 136 in the order of their input and, thereafter, the slips are sent to the banking system 100 as the replies 138. The message writing-in establishing unit 134 confirms that the storage by the output of the slips to the output queue 136 has been completed, and erases the slips having the same slip unique number stored in the input queue 102. The line of the slip multiple processing in FIGS. 16A and 16B as described above is provided for each line for which assurance of the slip order is necessary and processes of a plurality of input/output queues and a program executing platform are started up and processing is executed.

The invention also provides a program that functions as middle-ware realizing the functions of the slip multiple processing unit 12 shown in FIG. 1 of the invention and the program can be realized as a program having process steps with the contents as shown in the flowcharts shown in FIGS. 8, 9, 11A, 11B, 13A and 13B. Furthermore, in the above embodiment, a case where the slip multiple processing of the invention is applied to a financial gateway system between banking systems is taken as an example as a specific embodiment of the invention. However, the invention can not originally be operation-dependent and, therefore, the invention can be applied to suitable business-use systems other than the above, that multiple-process arbitrary slips without making any change thereto. Furthermore, the invention includes any suitable modifications thereto without impairing the objects and advantages thereof and, furthermore, is not limited by any numerical values indicated in the above embodiments.

1. A program operable to cause a computer to execute:
an input retaining step of inputting a slip with a unique number and retaining the slip in an input queue;
an input processing step of taking out slips of the number corresponding to multiplicity level of business-related processes, in the order of their age, from the slips retained in the input queue, assigning a management number to each of the corresponding number of slips, and thereafter, consolidating the corresponding number of slips to produce a consolidated-format slip;
a multiple processing step with one (1) or more stages, of dividing the consolidated-format slip into single slips and executing business-related processes of the number corresponding to the multiplicity level in parallel as well as outputting the processed single slips after consolidation into the consolidated-format slip; and
an output processing step of dividing the consolidated-format slip obtained from the multiple processing step into single slips and outputting the divided single slips in the order of their input.

2. The program according to claim 1, wherein the business-related processes in the multiple processing step includes executing a slip modification, summation, result storage or communication.

3. The program according to claim 1, further operable to cause the computer to execute a multiplicity level adjusting step of adjusting the value of the multiplicity level based on a processing sufficiency rate in the multiple processing step.

4. The program according to claim 3, wherein the multiplicity level adjusting step includes:
a step of obtaining the rate of the number of times of multiple processing of slips of the number satisfying the current multiplicity level, against the number of times of multiple processing per unit time, as the processing sufficiency rate;
a multiplicity level increasing step of increasing the multiplicity level as a result of determining that the current multiplicity level is not sufficient when the processing sufficiency rate is larger than a predetermined increase threshold value; and
a multiplicity level decreasing step of decreasing the multiplicity level as a result of determining that the current multiplicity level is excessive when the processing sufficiency rate is smaller than a predetermined decrease threshold value..

5. The program according to claim 4, wherein the multiplicity level increasing step includes:
multiplying the current multiplicity level by a coefficient obtained by adding a predetermined increment to 1 (one) to find an increased multiplicity level and, when the increased multiplicity level reaches a predetermined maximal value, fixing the multiplicity level at the maximal value, and wherein
the multiplicity level decreasing step includes:
multiplying the current multiplicity level by a coefficient obtained by subtracting a predetermined decrement from 1 (one) to find a decreased multiplicity level and, when the decreased multiplicity level reaches a predetermined minimal value, fixing the multiplicity level at the minimal value.

6. The program according to claim 1, wherein
the input retaining step includes retaining in the input queue a slip having a unique number and a group number that designates consolidated processing, and wherein
the input processing step includes retrieving, in the order of input, slips of the number corresponding to the multiplicity level of the business-related processes including the oldest input slip having the same group number, and consolidating the retrieved slips to produce a consolidated format slip.

7. The program according to claim 1, further operable to cause the computer to execute:
a history storage step of storing history information including a unique number, a management number, and information specific to business-related processes during a first slip process in the multiple processing step; and
a re-processing step of, when the slip is returned to the input retaining step and is re-processed being included in the consolidated-format slip in the input processing step, succeeding the information specific to the last business-related process by referring to the history information and causing the multiple processing step to execute the same process based on the information specific to the business-related process.

8. The program according to claim 7, wherein the re-processing step includes, if a plurality of slips have the same management number, taking out slips for a first process and taking out slips except those for the first process in the next process when the history information is referred to in the slip retrieval for producing the consolidated-format slip in the input processing step.

9. The program according to claim 1, further operable to cause the computer to execute a re-processing step of storing a consolidated-format slip in an internal queue at an intermediate stage of the multiple processing step including from the input processing step to the output processing step, and resuming the process from a consolidated-format slip stored in the internal queue used in the multiple processing step already executed when processing has failed during a specific step in the multiple processing step.

10. The program according to claim 9, wherein the re-processing step includes deleting a consolidated-format slip stored in the internal queue in a preceding multiple processing step when a consolidated-format slip is stored in the internal queue in a following multiple processing step.

11. A slip multiple processing method comprising:
an input retaining step of inputting a slip with a unique number and retaining the slip in an input queue;
an input processing step of taking out slips of the number corresponding to the multiplicity level of business-related processes, in the order of their age, from the slips retained in the input queue, assigning a management number to each of the corresponding number of slips, and thereafter, consolidating the corresponding number of slips to produce a consolidated-format slip;
a multiple processing step with one (1) or more stages, of dividing the consolidated-format slip into single slips and executing business-related processes of the number corresponding to the multiplicity level in parallel as well as outputting the processed single slips after consolidation into the consolidated-format slip; and
an output processing step of dividing the consolidated-format slip obtained from the multiple processing step into single slips and outputting the divided single slips in the order of their input.

12. A slip multiple processing apparatus comprising:
an input retaining unit for inputting a slip with a unique number and retaining the slip in an input queue;
an input processing unit for taking out slips of the number corresponding to the multiplicity level of business-related processes, in the order of their age, from the slips retained in the input queue, the input processing unit assigning a management number to each of the corresponding number of slips, and thereafter consolidating the corresponding number of slips to produce a consolidated-format slip;
a multiple processing unit with one (1) or more stages, for dividing the consolidated-format slip into single slips and executing business-related processes of the number corresponding to the multiplicity level in parallel, the multiple processing unit outputting the processed single slips after consolidation into the consolidated-format slip; and
an output processing unit for dividing the consolidated-format slip obtained from the multiple processing unit into single slips and outputting the divided single slips in the order of their input.
